(19) United States
(12) Patent Application Publication
(10) Pub. No.: US 2019/0072764 A1
(43) Pub. Date: Mar. 7, 2019

(54) OPTICAL REFLECTION MODULE OF HEAD UP DISPLAY

(71) Applicant: TAN CIAN TECHNOLOGY CO., LTD., Taichung (TW)

(72) Inventors: PO-CHE LEE, Taichung (TW); TZU CHIEN TANG, Taichung (TW)

(21) Appl. No.: 15/696,625

(22) Filed: Sep. 6, 2017

(51) Int. Cl. G02B 27/01

(52) U.S. Cl. CPC G02B 27/0101; G02B 2027/013; G02B 2027/0138; G02B 2027/0118

(57) ABSTRACT

An optical reflecting module of a head up display (HUD) is configured to reflect an image ray provided by an image generator to be imaged on an image portion. The optical reflecting module includes a front mirror, a multi-reflecting mirror, and a curved mirror. The image ray is reflected by the multi-reflecting mirror at least twice that could reduce a number of mirrors, and reduce a size and a weight of the optical reflecting module of the HUD.

### BACKGROUND OF THE INVENTION

### 1. Technical Field

The present invention relates to a head up display, and more particularly to an optical reflection module of head up display.

### 2. Description of Related Art

In early days, head up displays (HUD) are applied to military planes only, which show messages on a display in front of the pilot to keep the pilot's head up. HUD may reduce the delay and fatigue of eyes when pilot repeatedly lowers his/her head to read the messages on the panel and rise to see outside of the plane.

Recently, more and more vehicles are equipped with HUD. The conventional HUD projects image signals onto a glass in front of the pilot or driver to show the message on the glass that makes the pilot or driver concentrate in flying or driving.

The conventional HUD mainly includes an image processing unit and an image displaying unit. The image processing unit. The image processing unit converts messages into image signals, and the image displaying unit projects the image signals onto the glass. Typically, the image displaying unit includes a plurality of mirrors to reflect the image signals.

Compare to the image processing unit, the image displaying unit is larger than the image processing unit, and in the image displaying unit there are a lot of spaces left for the mirrors and for the image signals to travel. In order to reduce the size of HUD, how to reduce the space in the image displaying unit is an important issue.

### BRIEF SUMMARY OF THE INVENTION

In view of the above, the primary objective of the present invention is to provide an optical reflection module of head up display (HUD), which is small and light to be mounted in a limited space.

In order to achieve the objective of the present invention, a head up display includes an image generator, an imaging portion, and an optical reflecting module between the image generator and the imaging portion. The image generator provides an image ray to be reflected by the optical reflecting module and imaged on the imaging portion. The optical reflecting module has a multi-reflecting mirror, which reflects the image ray at least twice.

In an embodiment, an optical reflecting module of a head up display is configured to reflect an image ray provided by an image generator to be imaged on an image portion. The optical reflecting module includes a multi-reflecting mirror and a curved mirror, wherein the multi-reflecting mirror reflects an image ray to the curved mirror, and then the curved mirror reflects the image ray to the multi-reflecting mirror.

In an embodiment, an optical reflecting module of a head up display is configured to reflect an image ray provided by an image generator to be imaged on an image portion. The optical reflecting module includes a front mirror, a multi-reflecting mirror, and a curved mirror, wherein the image ray is reflected by the multi-reflecting mirror a plurality of times, the image ray is reflected by the curved mirror between two times of the image ray being reflected by the multi-reflecting mirror, and the image ray is reflected by the front mirror before the image ray is reflected by the multi-reflecting mirror.

The prevent invention provides the multi-reflecting mirror to reflect the image ray a plurality of times that could reduce a number of mirrors, and reduce the size and weight of the optical reflecting module of the HUD.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a sketch diagram of a first preferred embodiment of the present invention;

FIG. 2 is a sketch diagram of a second preferred embodiment of the present invention;

FIG. 3 is a sketch diagram of a third preferred embodiment of the present invention;

FIG. 4 is a sketch diagram of a fourth preferred embodiment of the present invention; and

FIG. 5 is a sketch diagram of a fifth preferred embodiment of the present invention.

### DETAILED DESCRIPTION OF THE INVENTION

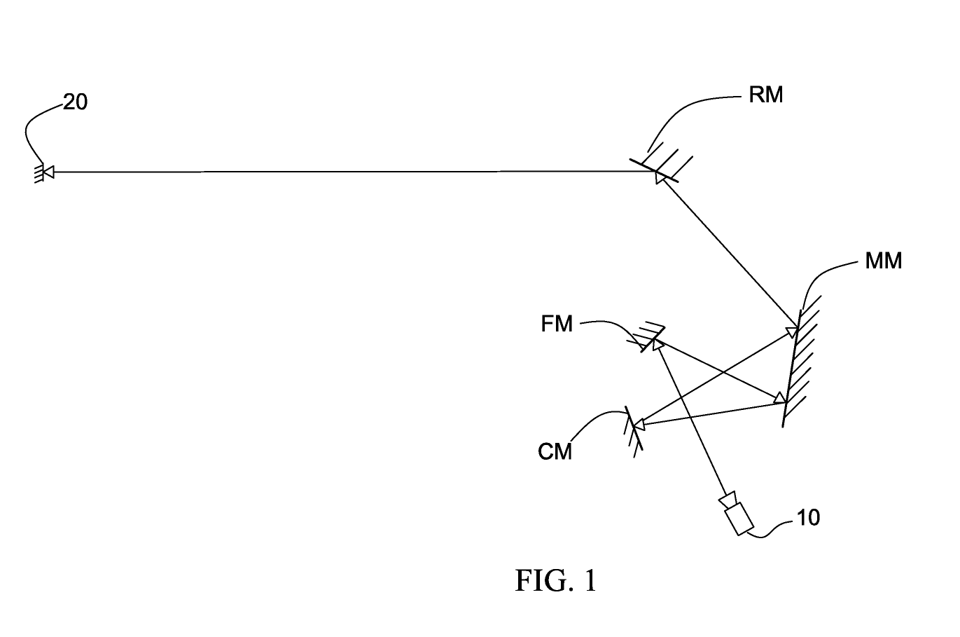

FIG. 1 shows a head up display (HUD) of the first preferred embodiment of the present invention. The HUD includes an image generator 10 at an object side, an imaging portion 20 at an image side, and an optical reflecting module between the image generator 10 and the imaging portion 20. The optical reflecting module includes a front mirror FM, a multi-reflecting mirror MM, a curved mirror CM, and a rear mirror RM. The image generator 10 provides an image ray, and the image ray is reflected by the mirrors to be imaged on the imaging portion 20. In the present preferred embodiment, the front mirror FM, the multi-reflecting mirror MM, and the rear mirror RM are flat mirrors, and the curved mirror CM is a concave mirror, and a radius of curvature thereof is −668.000000 mm.

The image generator 10 emits the image ray to the front mirror FM; and the front mirror FM reflects the image ray (an incident angle is 18.1 degrees) to the multi-reflecting mirror MM, and then the multi-reflecting mirror MM reflects the image ray (an incident angle is 23.9 degrees) to the curved mirror CM; and then the curved mirror CM reflects the image ray (an incident angle is 10.2 degrees) to the multi-reflecting mirror MM again; and then the multi-reflecting mirror MM reflects the image ray (an incident angle is 41 degrees) to the rear mirror RM, and finally the rear mirror RM reflects the image ray to the imaging portion 20.

Optical characters of the mirrors of the first preferred embodiment are listed in Table 1:

TABLE 1

| Reflecting | Type of reflecting | Radius of curvature | Incident angle |
|---|---|---|---|
| surface | surface | (mm) | (degree) |
| Object | spherical | Infinity | — |
| Stop | spherical | Infinity | — |
| FM | spherical | Infinity | 18.1 |
| MM | spherical | Infinity | 23.9 |
| CM | aspheric | −668.000000 | 10.2 |
| MM | spherical | Infinity | 41 |
| RM | spherical | Infinity | — |
| Image | spherical | Infinity | — |

The image ray is reflected by the multi-reflecting mirror MM twice when the image ray emits to the imaging portion 20. A traveling path of the image ray crosses in a space between the multi-reflecting mirror MM and the curved mirror CM that may reduce a number of the mirrors and a space for the image ray traveling. As a result, the optical reflecting module of the present invention will have a small size, and a light weight, and furthermore, a cost is reduced accordingly.

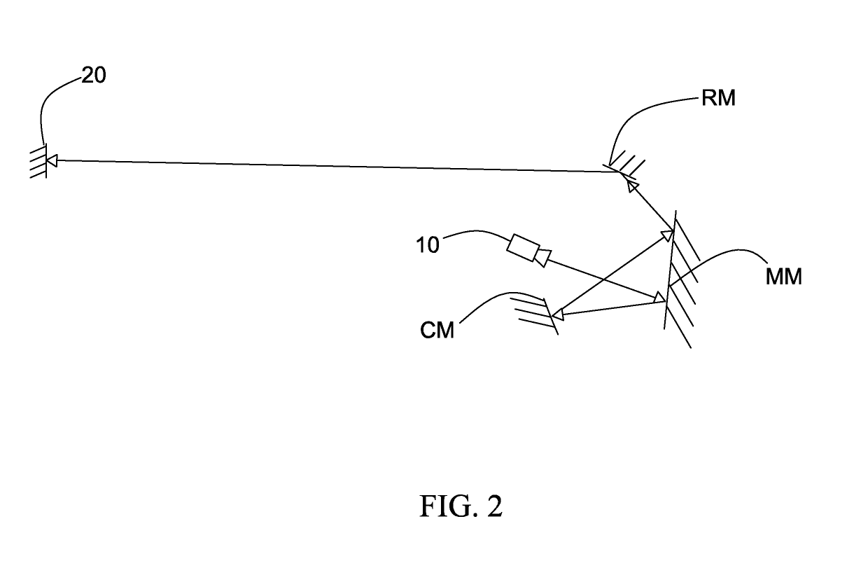

FIG. 2 shows a head up display (HUD) of the second preferred embodiment of the present invention. The HUD includes an image generator 10 at an object side, an imaging portion 20 at an image side, and an optical reflecting module between the image generator 10 and the imaging portion 20. The optical reflecting module includes a multi-reflecting mirror MM, a curved mirror CM, and a rear mirror RM. The image generator 10 provides an image ray, and the image ray is reflected by the mirrors to be imaged on the imaging portion 20. In the present preferred embodiment, the multi-reflecting mirror MM and the rear mirror RM are flat mirrors, and the curved mirror CM is a concave mirror, and a radius of curvature thereof is −1405.57781 mm.

The image generator 10 emits the image ray to the multi-reflecting mirror MM, and the multi-reflecting mirror MM reflects the image ray (an incident angle is 23.9 degrees) to the curved mirror CM; and then the curved mirror CM reflects the image ray (an incident angle is 9.2 degrees) to the multi-reflecting mirror MM again; and then the multi-reflecting mirror MM reflects the image ray (an incident angle is 42.3 degrees) to the rear mirror RM, and finally the rear mirror RM reflects the image ray to the imaging portion 20.

Optical characters of the mirrors of the second preferred embodiment are listed in Table 2:

TABLE 2

| Reflecting | Type of reflecting | Radius of curvature | Incident angle |
|---|---|---|---|
| surface | surface | (mm) | (degree) |
| Object | spherical | Infinity | — |
| Stop | spherical | Infinity | — |
| MM | spherical | Infinity | 23.9 |
| CM | spherical | −1405.57781 | 9.2 |
| MM | spherical | Infinity | 42.3 |
| RM | spherical | Infinity | — |
| Image | spherical | Infinity | — |

The functions and advantages of the optical reflecting module of the second preferred embodiment are the same as above, so I do not describe them again.

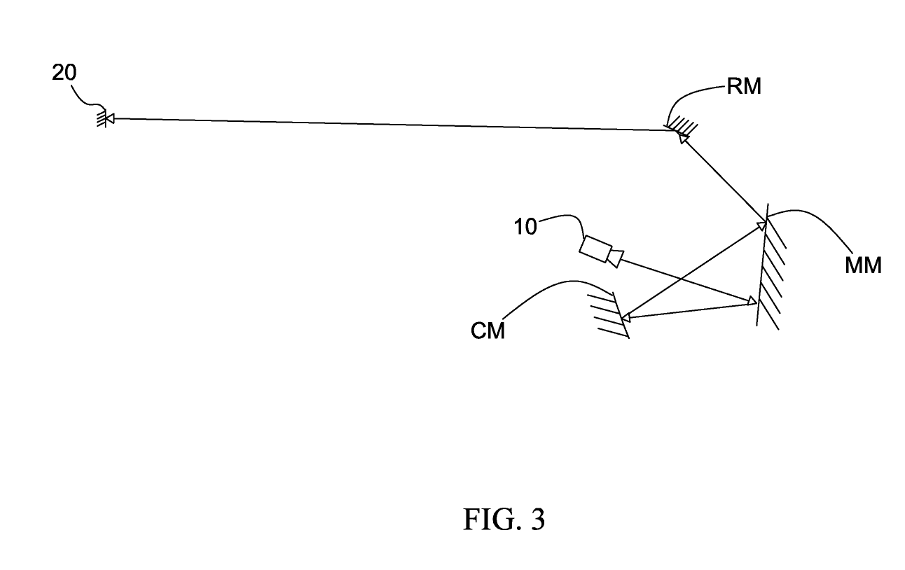

FIG. 3 shows a head up display (HUD) of the third preferred embodiment of the present invention. The HUD includes an image generator 10 at an object side, an imaging portion 20 at an image side, and an optical reflecting module between the image generator 10 and the imaging portion 20. The optical reflecting module includes a multi-reflecting mirror MM, a curved mirror CM, and a rear mirror RM. The image generator 10 provides an image ray, and the image ray is reflected by the mirrors to be imaged on the imaging portion 20. In the present preferred embodiment, the rear mirror RM is a flat mirror, the multi-reflecting mirror MM and the curved mirror CM are concave mirror, and a radius of curvature of the multi-reflecting mirror MM is 78920.46726 mm, and a radius of curvature of the curved mirror CM is −376.973185 mm.

The image generator 10 emits the image ray to the multi-reflecting mirror MM, and the multi-reflecting mirror MM reflects the image ray (an incident angle is 24.3 degrees) to the curved mirror CM; and then the curved mirror CM reflects the image ray (an incident angle is 8.9 degrees) to the multi-reflecting mirror MM again; and then the multi-reflecting mirror MM reflects the image ray (an incident angle is 42.6 degrees) to the rear mirror RM, and finally the rear mirror RM reflects the image ray to the imaging portion 20.

Optical characters of the mirrors of the third preferred embodiment are listed in Table 3:

TABLE 3

| Reflecting | Type of reflecting | Radius of curvature | Incident angle |
|---|---|---|---|
| surface | surface | (mm) | (degree) |
| Object | spherical | Infinity | — |
| Stop | spherical | Infinity | — |
| MM | XY Polyn | 78920.467206 | 24.3 |
| CM | XY Polyn | −376.973185 | 8.9 |
| MM | XY Polyn | 78920.467206 | 42.6 |
| RM | spherical | Infinity | — |
| Image | spherical | Infinity | — |

In the third preferred embodiment, the sags of the multi-reflecting mirror MM and the curved mirror CM are obtained by the following equation:

$$z = \frac{{cr}^{2}}{1 \to \sqrt{1 - ( 1 + k ) {c}^{2} {r}^{2}}} + {\sum }_{j = 2}^{66} {c}_{j} {x}^{m} {y}^{n}$$

$$j = \frac{{( m + n )}^{2} + m + 3 n}{2} + 1$$

where
z is the sag of the surface parallel to the z-axis;
c is the vertex curvature (CUY);
k is the conic constant; and
Cⱼ is the coefficient of the monomial x^{m}yⁿ.

The parameters of the multi-reflecting mirror MM and the curved mirror CM are listed in the following table:

| | MM | CM |
|---|---|---|
| Y Radius | 78920.47 | −376.973 |
| Normalization Radius | 350 | 250 |
| Conic Constant | 0 | 0 |
| X | 0 | 0 |
| Y | −0.94695 | −0.5006 |
| X² | 66.81792 | 41.19396 |
| XY | 0 | 0 |
| Y² | 0.851253 | 10.98079 |
| X³ | 0 | 0 |
| X²Y | 37.38358 | 39.21951 |
| XY² | 0 | 0 |
| Y³ | 0.83536 | 4.877157 |
| X⁴ | −42.3309 | 2.501827 |
| X³Y | 0 | 0 |
| X²Y² | −41.8038 | 20.05171 |
| XY³ | 0 | 0 |
| Y⁴ | −6.93035 | 5.881796 |

The functions and advantages of the optical reflecting module of the third preferred embodiment are the same as above, so I do not describe them again.

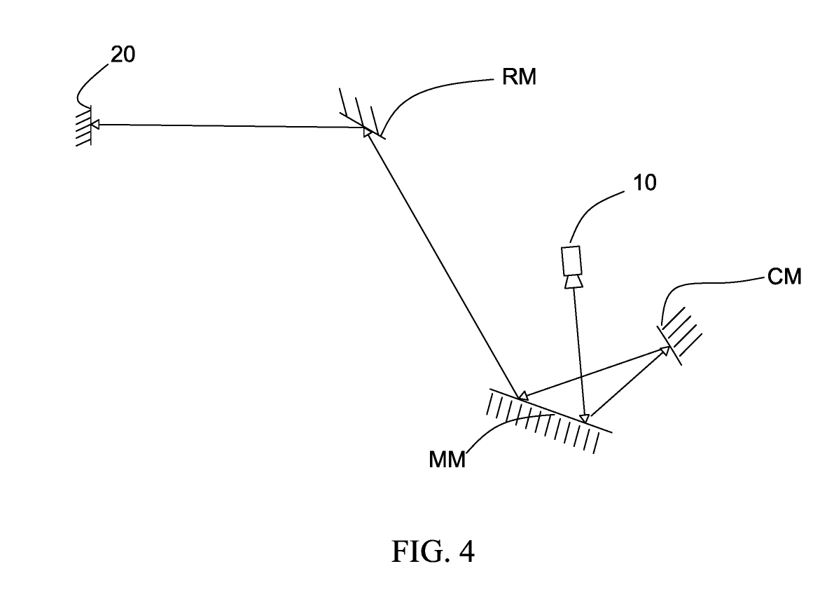

FIG. 4 shows a head up display (HUD) of the fourth preferred embodiment of the present invention. The HUD includes an image generator 10 at an object side, an imaging portion 20 at an image side, and an optical reflecting module between the image generator 10 and the imaging portion 20. The optical reflecting module includes a multi-reflecting mirror MM, a curved mirror CM, and a rear mirror RM. The image generator 10 provides an image ray, and the image ray is reflected by the mirrors to be imaged on the imaging portion 20. In the present preferred embodiment, the multi-reflecting mirror MM and the rear mirror RM are flat mirrors, and the curved mirror CM is a concave mirror, and a radius of curvature thereof is −520.000000 mm.

The image generator 10 emits the image ray to the multi-reflecting mirror MM, and the multi-reflecting mirror MM reflects the image ray (an incident angle is 31 degrees) to the curved mirror CM; and then the curved mirror CM reflects the image ray (an incident angle is 9.5 degrees) to the multi-reflecting mirror MM again; and then the multi-reflecting mirror MM reflects the image ray (an incident angle is 50 degrees) to the rear mirror RM, and finally the rear mirror RM reflects the image ray to the imaging portion 20.

Optical characters of the mirrors of the fourth preferred embodiment are listed in Table 4:

TABLE 4

| Reflecting | Type of reflecting | Radius of curvature | Incident angle |
|---|---|---|---|
| surface | surface | (mm) | (degree) |
| Object | spherical | Infinity | — |
| Stop | spherical | Infinity | — |
| MM | spherical | Infinity | 31 |
| CM | spherical | −520.000000 | 9.5 |
| MM | spherical | Infinity | 50 |
| RM | spherical | Infinity | — |
| Image | spherical | Infinity | — |

The functions and advantages of the optical reflecting module of the fourth preferred embodiment are the same as above, so I do not describe them again.

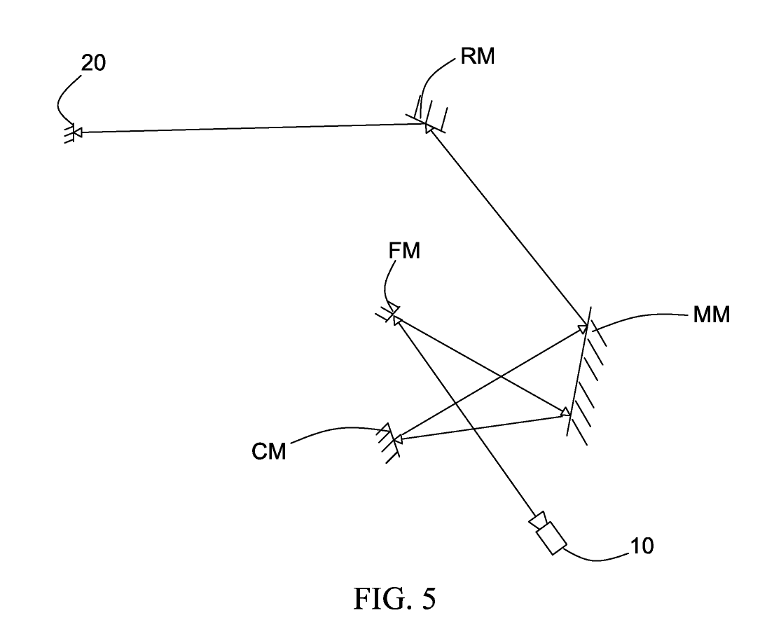

FIG. 5 shows a head up display (HUD) of the fifth preferred embodiment of the present invention. The HUD includes an image generator 10 at an object side, an imaging portion 20 at an image side, and an optical reflecting module between the image generator 10 and the imaging portion 20. The optical reflecting module includes a front mirror FM, a multi-reflecting mirror MM, a curved mirror CM, and a rear mirror RM. The image generator 10 provides an image ray, and the image ray is reflected by the mirrors to be imaged on the imaging portion 20. In the present preferred embodiment, the multi-reflecting mirror MM and the rear mirror RM are flat mirrors, and the front mirror FM and the curved mirror CM are concave mirrors. A radius of curvature of the front mirror FM is −884.664951 mm, and a radius of curvature of the curved mirror CM is −1405.577881.

The image generator 10 emits the image ray to the front mirror FM, and the front mirror FM reflects the image ray to (an incident angle of 12.8 degrees) the multi-reflecting mirror MM, and then the multi-reflecting mirror MM reflects the image ray (an incident angle is 19.4 degrees) to the curved mirror CM; and then the curved mirror CM reflects the image ray (an incident angle is 10 degrees) to the multi-reflecting mirror MM again; and then the multi-reflecting mirror MM reflects the image ray (an incident angle is 39.4 degrees) to the rear mirror RM, and finally the rear mirror RM reflects the image ray to the imaging portion 20.

Optical characters of the mirrors of the fifth preferred embodiment are listed in Table 5:

TABLE 5

| Reflecting | Type of reflecting | Radius of curvature | Incident angle |
|---|---|---|---|
| surface | surface | (mm) | (degree) |
| Object | spherical | Infinity | — |
| Stop | spherical | Infinity | — |
| FM | spherical | −884.664951 | 12.8 |
| MM | spherical | Infinity | 19.4 |
| CM | spherical | −1405.57781 | 10 |
| MM | spherical | Infinity | 39.4 |
| RM | spherical | Infinity | — |
| Image | spherical | Infinity | — |

The functions and advantages of the optical reflecting module of the fifth preferred embodiment are the same as above, so I do not describe them again.

The prevent invention provides the multi-reflecting mirror MM to reflect the image ray twice or more that could reduce a number of mirrors, and reduce the size and weight of the optical reflecting module of the HUD.

It must be pointed out that the embodiments described above are only some preferred embodiments of the present invention. All equivalent structures which employ the concepts disclosed in this specification and the appended claims should fall within the scope of the present invention.

What is claimed is:

1. A head up display, comprising:
an image generator providing an image ray;
an optical reflecting module having a multi-reflecting mirror to reflect the image ray at least twice; and
an imaging portion, on which the image ray reflected by the optical reflecting module is imaged.

2. The head up display of claim 1, wherein the optical reflecting module further has a curved mirror, wherein the image ray is reflected by the curved mirror between two times of the image ray being reflected by the multi-reflecting mirror.

3. The head up display of claim 2, wherein the curved mirror is a concave mirror, and a radius of curvature of the curved mirror is in a range between −1405.57781 mm and −376.973185 mm.

4. The head up display of claim 2, wherein both the multi-reflecting mirror and the curved mirror are concave mirrors.

5. The head up display of claim 2, wherein the multi-reflecting mirror is a flat mirror, and the curved mirror is a concave mirror.

6. The head up display of claim 2, wherein the optical reflecting module further has a front mirror, wherein the image ray is reflected by the front mirror before the image ray is reflected by the multi-reflecting mirror.

7. The head up display of claim 6, wherein the front mirror is a concave mirror.

8. The head up display of claim 1, wherein an incident angle of the image ray being reflected by the multi-reflecting mirror for the first time is in a range between 39.4 degrees and 50 degrees.

9. The head up display of claim 1, wherein an incident angle of the image ray being reflected by the multi-reflecting mirror for the second time is in a range between 19.4 degrees and 31 degrees.

10. The head up display of claim 2, wherein an incident angle of the image ray being reflected by the curved mirror is in a range between 8.9 degrees and 10.2 degrees.

11. The head up display of claim 6, wherein an incident angle of the image ray being reflected by the front mirror is in a range between 8.1 degrees and 12.8 degrees.

12. An optical reflecting module of a head up display, which is configured to reflect an image ray provided by an image generator to be imaged on an image portion, comprising a multi-reflecting mirror and a curved mirror, wherein the multi-reflecting mirror reflects an image ray to the curved mirror, and then the curved mirror reflects the image ray to the multi-reflecting mirror before the image ray is imaged on the image portion.

13. The optical reflecting module of the head up display of claim 12, wherein the curved mirror is a concave mirror, and a radius of curvature of the curved mirror is in a range between −1405.57781 mm and −376.973185 mm.

14. The optical reflecting module of the head up display of claim 12, wherein both the multi-reflecting mirror and the curved mirror are concave mirrors.

15. The optical reflecting module of the head up display of claim 12, wherein the multi-reflecting mirror is a flat mirror, and the curved mirror is a concave mirror.

16. The optical reflecting module of the head up display of claim 12, wherein an incident angle of the image ray being reflected by the multi-reflecting mirror is in a range between 19.4 degrees and 50 degrees.

17. The optical reflecting module of the head up display of claim 12, wherein an incident angle of the image ray being reflected by the curved mirror is in a range between 8.9 degrees and 10.2 degrees.

18. The optical reflecting module of the head up display of claim 12, further comprising a front mirror, wherein the image ray is reflected by the front mirror before the image ray is reflected by the multi-reflecting mirror, and an incident angle of the image ray being reflected by the front mirror is in a range between 8.1 degrees and 12.8 degrees.

19. An optical reflecting module of a head up display, which reflects an image ray provided by an image generator to be imaged on an image portion, comprising a front mirror, a multi-reflecting mirror, and a curved mirror, wherein the image ray is reflected by the multi-reflecting mirror a plurality of times, the image ray is reflected by the curved mirror between two times of the image ray being reflected by the multi-reflecting mirror, and the image ray is reflected by the front mirror before the image ray is reflected by the multi-reflecting mirror.

20. The optical reflecting module of the head up display of claim 19, wherein the curved mirror is a concave mirror.
